(19) United States
(12) Patent Application Publication
(10) Pub. No.: US 2017/0329986 A1
(43) Pub. Date: Nov. 16, 2017

(54) METHOD AND DEVICE FOR PROCESSING MULTIMEDIA FILE

(71) Applicant: TENCENT TECHNOLOGY (SHENZHEN) COMPANY LIMITED, Shenzhen (CN)

(72) Inventor: Liwei ZHANG, Shenzhen (CN)

(21) Appl. No.: 15/666,209

(22) Filed: Aug. 1, 2017

Related U.S. Application Data
(63) Continuation of application No. PCT/CN2016/079743, filed on Apr. 20, 2016.

(30) Foreign Application Priority Data
Jun. 24, 2015 (CN) 201510354082.4

(51) Int. Cl. G06F 21/62; G06F 21/10; G06Q 50/18

(52) U.S. Cl. CPC G06F 21/6209; G06Q 50/184; G06F 21/10; G06F 2221/2107; G06Q 2220/16

(57) ABSTRACT

A method and a device for processing a multimedia file are provided. In some embodiments, for a multimedia file to be processed, encoding information of the multimedia file is acquired, and some of the encoding information is selected as the encoding information to be encrypted. The encoding information to be encrypted is encrypted. New encoding information is formed by the encrypted encoding information and the unencrypted encoding information, and the new encoding information is encoded to obtain the encoded multimedia file. With the solutions, copyrights of the multimedia file can be protected better.

### CROSS REFERENCE TO RELATED APPLICATION

The present application is a continuation of International Application No. PCT/CN2016/079743, filed on Apr. 20, 2016, which claims the priority to Chinese Patent Application No. 201510354082.4, titled “METHOD AND DEVICE FOR PROCESSING MULTIMEDIA FILE”, filed on Jun. 24, 2015 with the State Intellectual Property Office of the People's Republic of China, both of which are incorporated herein by reference in their entireties.

### TECHNICAL FIELD

The present disclosure relates to the field of multimedia technology, and in particular to a method and a device for processing a multimedia file.

### BACKGROUND

With the development of mobile internet technology, more and more multimedia content providers publish and sell multimedia information over a network. Because of the uncontrollability of the internet and characteristics of digital media, such as the lossless copy and transmission, the copyright protection of digital multimedia information becomes very difficult.

With respect to this problem, a conventional solution is generally to limit different users to enjoy and download different multimedia files by setting user rights. For example, a multimedia content provider only permits a paid user to enjoy and download specific copyrighted multimedia files. However, the user with permission may issue the downloaded high-quality multimedia files onto the network, and other users can also enjoy the high-quality multimedia files even without the permission. Obviously, although the conventional technology has limited piracy to some extent, there is still a need for improved techniques to further protect the copyright of digital multimedia information.

### SUMMARY

In view of the above, a method and a device for processing a multimedia file are provided according to the present disclosure, to solve the problem that the copyrights of digital multimedia information cannot be fully protected in conventional technology.

A method for processing a multimedia file is provided, which includes acquiring encoding information of a multimedia file to be processed. The method further includes selecting encoding information to be encrypted from the encoding information based on a pre-set strategy. The method further includes encrypting the encoding information to be encrypted, and forming new encoding information by the encrypted encoding information and unencrypted encoding information. The method further includes encoding the new encoding information to obtain an encoded multimedia file.

A method for processing a multimedia file is provided, which includes decoding a target multimedia file, in response to an operation of triggering the target multimedia file by a user, to obtain encoding information of the target multimedia file. The encoding information includes encrypted encoding information and unencrypted encoding information. The method further includes determining whether the user has permission to decrypt the target multimedia file. The method further includes performing multimedia playback by using the unencrypted encoding information in the encoding information, in a case that it is determined that the user does not have the permission to decrypt the target multimedia file. The method further includes decrypting the encrypted encoding information to obtain decrypted encoding information, in a case that it is determined that the user has the permission to decrypt the target multimedia file. The method further includes performing multimedia playback by using the decrypted encoding information and the unencrypted encoding information.

A device for processing a multimedia file is provided, which includes an encoding information acquiring unit configured to acquire encoding information of a multimedia file to be processed. The device further includes an encoding information selecting unit configured to select encoding information to be encrypted from the encoding information based on a pre-set strategy. The device further includes an encryption processing unit configured to encrypt the encoding information to be encrypted, and form new encoding information by the encrypted encoding information and the unencrypted encoding information. The device further includes an encoding processing unit configured to encode the new encoding information to obtain an encoded multimedia file.

A device for processing a multimedia file is provided, which includes a multimedia file decoding unit configured to decode a target multimedia file, in response to an operation of triggering the target multimedia file by a user, to obtain encoding information of the target multimedia file. The encoding information includes encrypted encoding information and unencrypted encoding information. The device further includes a user permission determining unit configured to determine whether the user has permission to decrypt the target multimedia file. The device further includes a first multimedia playback unit configured to perform multimedia playback by using the unencrypted encoding information in the encoding information, in a case of a negative determination from the user permission determining unit.

The device further includes a decryption processing unit configured to decrypt the encrypted encoding information to obtain decrypted encoding information, in a case of a positive determination from the user permission determining unit. The device further includes a second multimedia playback unit configured to perform multimedia playback by using the decrypted encoding information and the unencrypted encoding information.

As can be seen from the above technical solutions, based on the method for processing a multimedia file according to embodiments of the present disclosure, for a multimedia file whose copyright is to be protected, encoding information of the multimedia file is acquired, and some of the encoding information is selected as the encoding information to be encrypted. The encoding information to be encrypted is encrypted. New encoding information is formed by the encrypted frame data and unencrypted frame data, and the new payload data is encoded to obtain an encoded multimedia file. For the multimedia file provided according to the solutions of the present application, only with the decryption permission corresponding to the multimedia file can a user decrypt and play the lossless multimedia file. Therefore, even though a user with the decryption permission transfers the downloaded multimedia file to other users, the other users will not be able to play the lossless multimedia file without the decryption permission of the multimedia file, thereby achieving the protection of the copyrights of the multimedia file.

Further, with the method for processing a multimedia file according to the present disclosure, the encryption depth of the encoding information may be controlled by adjusting the pre-set strategy. For users without the decryption permission, they cannot enjoy the decrypted lossless multimedia file, but can still play the multimedia file with a low quality, and the play quality may be controlled by providers by adjusting the pre-set category.

### BRIEF DESCRIPTION OF THE DRAWINGS

To illustrate technical solutions according to embodiments of the present disclosure or in the conventional technologies more clearly, drawings to be used in the descriptions of the conventional technologies or the embodiments are described briefly hereinafter. Apparently, the drawings described hereinafter are only for some embodiments of the present disclosure, and other drawings may be obtained by those skilled in the art based on those drawings without creative efforts.

FIG. 1 is a flow chart of a method for processing a multimedia file according to an embodiment of the present disclosure;

FIG. 2 is a schematic structural diagram of a device for processing a multimedia file according to an embodiment of the present disclosure;

FIG. 3 is a schematic structural diagram of an encoding information acquiring unit according to an embodiment of the present disclosure;

FIG. 4 is a schematic structural diagram of an encoding information selecting unit according to an embodiment of the present disclosure;

FIG. 5 is a schematic structural diagram of an encryption processing unit according to an embodiment of the present disclosure;

FIG. 6 is a flow chart of a method for processing a multimedia file according to another embodiment of the present disclosure;

FIG. 7 is a schematic structural diagram of a device for processing a multimedia file according to another embodiment of the present disclosure; and

FIG. 8 is a schematic diagram of a hardware structure of a server according to an embodiment of the present disclosure.

### DETAILED DESCRIPTION OF THE EMBODIMENTS

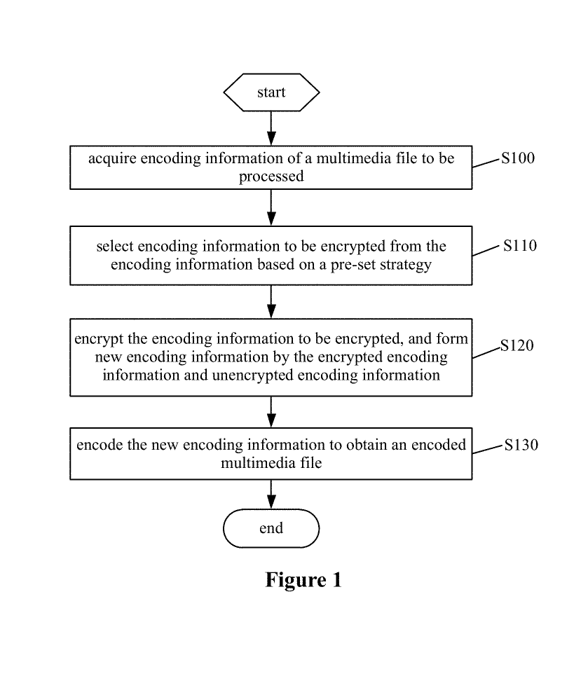

Reference is made to FIG. 1, which is a flow chart of a method for processing a multimedia file according to an embodiment of the present disclosure.

As shown in FIG. 1, the method includes steps S100 to S130.

In step S100, encoding information of a multimedia file to be processed is acquired.

For the multimedia file whose copyright needs to be protected, the following processing may be performed according to the solutions of the present disclosure. The multimedia file may be music, video, text, or any combination thereof.

In step S110, encoding information to be encrypted is selected from the encoding information based on a pre-set strategy.

For the obtained encoding information, some or all of the encoding information may be selected as the encoding information to be encrypted based on the pre-set strategy.

It is to be understood that, the more the selected encoding information to be encrypted is, the deeper the encryption depth is.

There may be various selection strategies, for example, selecting according to positions or lengths of the encoding information in the whole encoding information.

In step S120, the encoding information to be encrypted is encrypted, and new encoding information is formed by the encrypted encoding information and unencrypted encoding information.

Some of the encoding information of the multimedia file to be processed is encrypted, and the other of the encoding information is not encrypted. The new encoding information is formed by the encrypted encoding information and the unencrypted encoding information.

In step S130, the new encoding information is encoded to obtain an encoded multimedia file.

Specifically, the multimedia file may be encoded by using an entropy coding method, and the encoded multimedia file may be uploaded to a website of a multimedia provider, for enjoying and downloading by users.

Based on the method for processing a multimedia file according to the embodiment of the present disclosure, for a multimedia file whose copyright is to be protected, encoding information of the multimedia file is acquired, and some of the encoding information is selected as the encoding information to be encrypted. The encoding information to be encrypted is encrypted. New encoding information is formed by the encrypted frame data and unencrypted frame data, and the new payload data is encoded to obtain an encoded multimedia file. For the multimedia file provided according to the solutions of the present application, only with the decryption permission corresponding to the multimedia file can a user decrypt and play the lossless multimedia file. Therefore, even though a user with the decryption permission transfers the downloaded multimedia file to other users, the other users will not be able to play the lossless multimedia file without the decryption permission of the multimedia file, thereby achieving the protection of the copyrights of the multimedia file.

Further, with the method for processing a multimedia file according to the present disclosure, the encryption depth of the encoding information may be controlled by adjusting the pre-set strategy. For users without the decryption permission, they cannot enjoy the decrypted lossless multimedia file, but can still play the multimedia file with a low quality, and the play quality may be controlled by providers by adjusting the pre-set category.

Generally, a multimedia file provider may provide an application APP to users to enjoy multimedia, such as a music player or a video player. In playing a multimedia file which has been encrypted, the application can decrypt the decoded multimedia file by means of a decryption algorithm pre-stored in the application or issued by a server, the decryption algorithm corresponding to the multimedia file. And then the lossless multimedia file can be played.

In order to facilitate understanding of the present disclosure, an example is taken in the following.

The multimedia file is regarded as a word document containing one hundred words. Each of the words may be regarded as the encoding information. Based on the method according to the present disclosure, starting from the first word, one word is selected from the hundred words at an interval of ten words, as the word to be encrypted. After the words to be encrypted are encrypted, a new word document is obtained.

If a user A has permission to view the word document, that is, having the permission to decrypt the encrypted words in the word document, the user A can decrypt and display all the encrypted words in the word document when viewing the word document. Therefore, the user A can browse the whole word document.

However, if a user B does not have the permission to view the word document, that is, not having the permission to decrypt the encrypted words in the word document, the user B can only browse the unencrypted words in the word document, but cannot view the encrypted words in the word document.

The quality of the multimedia file viewed by the user without the permission may be controlled by adjusting the pre-set strategy.

Optionally, the encoding information of the multimedia file to be processed may be acquired by decoding the compressed multimedia file to be processed. In the conventional technology, an entropy encoding method is generally adopted for codding and compressing. Therefore, an entropy decoding method may be adopted for decoding.

Optionally, various encryption algorithms may be adopted to encrypt the encoding information to be encrypted. In some embodiments, a permutation encryption algorithm may be adopted. A format of the multimedia file processed by the permutation encryption algorithm is compatible, that is, a user without the decryption permission can use other multimedia player to play the processed multimedia file, but the quality of the multimedia may be low. The quality of the multimedia is controlled by the encryption depth.

The process of encrypting the encoding information will be described in conjunction with an embodiment of the present disclosure.

It can be understood by those skilled in the art that, the encoding information described herein may include a quantization parameter and several Discrete Cosine Transform (DCT) coefficients. Therefore, the quantization parameter in the encoding information may be selected as the encoding information to be encrypted for encryption processing. Alternatively, a pre-set number of DCT coefficients of the several DCT coefficients may be selected for encryption processing, and which of the several DCT coefficients are selected for encryption processing may be pre-set. Alternatively, both of the quantization parameter and a pre-set number of DCT coefficients of the several DCT coefficients may be selected for encryption processing.

It is to be understood that, the more the encrypted encoding information is, the deeper the encryption depth is. For a user without the decryption permission, the quality of a multimedia file enjoyed by the user will be lower.

In the following, an example is taken for illustration in which the multimedia file is music.

Assumed that a provider 1 wants to protect the copyright of a song A, the song A may be encrypted by means of the above encryption method according to the embodiment of the present disclosure, and the encrypted song A is issued onto a target website of the provider 1. The provider 1 may set that only a paid member user has the decryption permission, i.e., only the paid member user can enjoy the lossless song A. When a paid member user successfully logs in the target website and clicks the song A for playback, a player provided by the target website can obtain a decryption algorithm corresponding to the song A, decode and decrypt the song A, and finally achieve the lossless playback of the song A.

Even if the paid member downloads the song A locally, and transfers it to other unpaid users, the unpaid users cannot decrypt the encrypted song A and play the lossless song A, no matter what kind of players are used, because the unpaid users do not have the decryption permission for the song A, thereby protecting the copyright of the song A.

In addition, the present disclosure does not encrypt the whole of the multimedia file, but encrypt some of the encoding information in the multimedia file, so that non-member users without the decryption permission can enjoy the multimedia file with a low quality, as well, thereby improving the friendliness of non-member users.

Hereinafter a device for processing a multimedia file according to an embodiment of the present disclosure is described. The device for processing a multimedia file described in the following may refer to the corresponding method for processing a multimedia file described in the above, mutually.

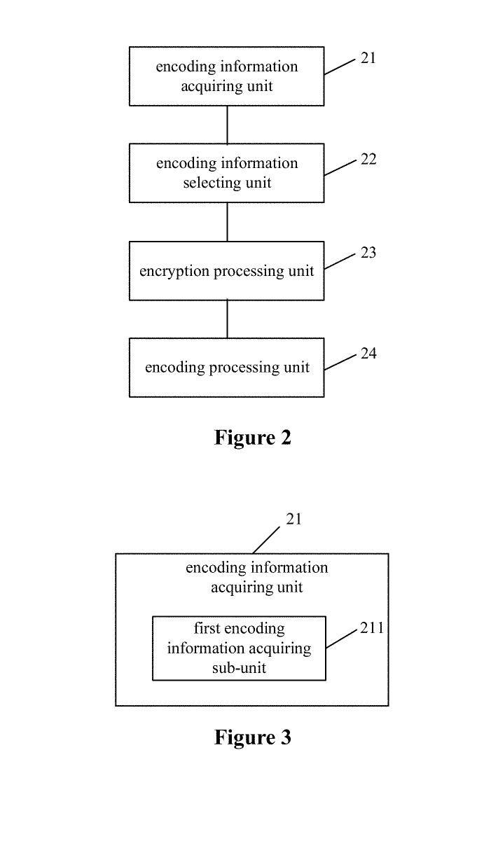

Reference is made to FIG. 2, which is a schematic structural diagram of a device for processing a multimedia file according to an embodiment of the present disclosure.

As shown in FIG. 2, the device includes an encoding information acquiring unit 21, an encoding information selecting unit 22, an encryption processing unit 23 and an encoding processing unit 24.

The encoding information acquiring unit 21 is configured to acquire encoding information of a multimedia file to be processed.

The encoding information selecting unit 22 is configured to select encoding information to be encrypted from the encoding information based on a pre-set strategy.

The encryption processing unit 23 is configured to encrypt the encoding information to be encrypted, and form new encoding information by the encrypted encoding information and unencrypted encoding information.

The encoding processing unit 24 is configured to encode the new encoding information to obtain an encoded multimedia file.

Optionally, as shown in FIG. 3, the encoding information acquiring unit 21 may include a first encoding information acquiring sub-unit 211.

The first encoding information acquiring sub-unit 211 is configured to decode the compressed multimedia file to be processed to obtain the encoding information of the multimedia file to be processed.

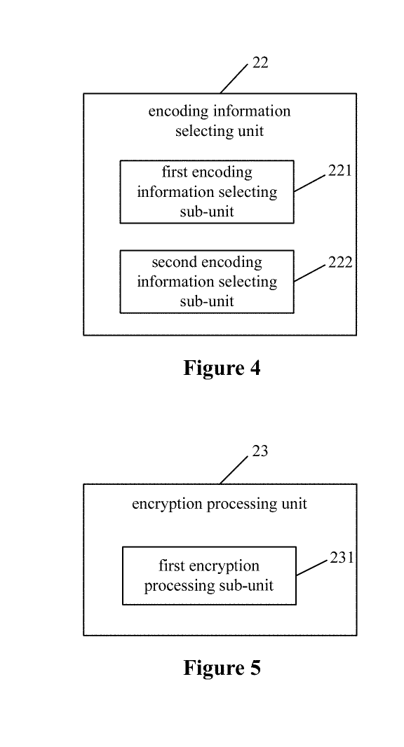

Optionally, the encoding information includes a quantization parameter and several discrete cosine transform DCT coefficients. As shown in FIG. 4, the encoding information selecting unit 22 may include a first encoding information selecting sub-unit 221 and a second encoding information selecting sub-unit 222.

The first encoding information selecting sub-unit 221 is configured to select the quantization parameter in the encoding information as the encoding information to be encrypted.

The second encoding information selecting sub-unit 222 is configured to select a pre-set number of DCT coefficients of all the DCT coefficients in the encoding information as the encoding information to be encrypted.

Optionally, as shown in FIG. 5, the above encryption processing unit 23 may include a first encryption processing sub-unit 231 configured to encrypt the encoding information to be encrypted by means of a permutation encryption algorithm.

Based on the device for processing a multimedia file according to the embodiment of the present disclosure, for a multimedia file whose copyright is to be protected, encoding information of the multimedia file is acquired, and some of the encoding information is selected as the encoding information to be encrypted. The encoding information to be encrypted is encrypted. New encoding information is formed by the encrypted frame data and the unencrypted frame data, and the new payload data is encoded to obtain an encoded multimedia file. For the multimedia file provided according to the solutions of the present application, only with the decryption permission corresponding to the multimedia file can a user decrypt and play the lossless multimedia file. Therefore, even though a user with the decryption permission transfers the downloaded multimedia file to other users, the other users will not be able to play the lossless multimedia file without the decryption permission of the multimedia file, thereby achieving the protection of the copyrights of the multimedia file.

Further, with the device for processing a multimedia file according to the present disclosure, the encryption depth of the encoding information may be controlled by adjusting the pre-set strategy. For users without the decryption permission, they cannot enjoy the decrypted lossless multimedia file, but can still play the multimedia file with a low quality, and the play quality may be controlled by providers by adjusting the pre-set category.

A method for processing a multimedia file is provided according to another embodiment of the present disclosure, to play the multimedia file obtained based on the above method. The method according to the embodiment may be applied to a player, and the player may be provided by a website of a multimedia provider.

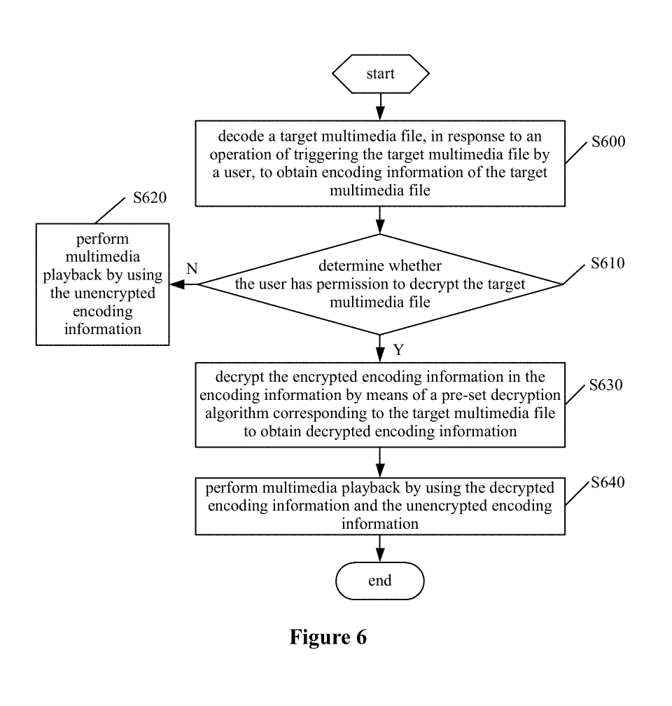

Reference is made to FIG. 6, which is a flow chart of a method for processing a multimedia file according to another embodiment of the present disclosure.

As shown in FIG. 6, the method includes steps S600 to S640.

In step S600, a target multimedia file is decoded, in response to an operation of triggering the target multimedia file by a user, to obtain encoding information of the target multimedia file.

Specifically, upon an operation of triggering a target multimedia file by a user, such as clicking, a player will receive and decode the target multimedia file. An entropy decoding method may be used in decoding. The encoding information of the target multimedia file may be obtained by decoding the target multimedia file.

According to an embodiment of the present disclosure, the encoding information includes encrypted encoding information and unencrypted encoding information.

In step S610, it is determined whether the user has permission to decrypt the target multimedia file. If not, the method proceeds to step S620, and if so, the method proceeds to step S630.

In step S620, multimedia playback is performed by using the unencrypted encoding information in the encoding information.

Specifically, it is determined whether the user has the permission to decrypt the target multimedia file according to whether the user has purchased the copyright of the target multimedia file, or according to whether the user identity meets a pre-set condition. For example, a website may upgrade the paid users to be member users, and the member users have the permission to decrypt all the target multimedia files.

In a case that it is detected that the user does not have the permission to decrypt the target multimedia file, multimedia playback is performed by directly using the encoding information. In this case, although the encoding information includes some of the encrypted encoding information, multimedia playback can still be achieved, but the quality of the played multimedia will be reduced.

In step S630, the encrypted encoding information is decrypted to obtain decrypted frame data.

According to an embodiment of the present disclosure, a pre-set decryption algorithm corresponding to the target multimedia file may be adopted for the decrypting.

The pre-set decryption algorithm corresponding to the target multimedia file matches an encryption algorithm used to encrypt the target multimedia file. The decryption algorithm may pre-store in a player, or obtained temporarily from a server, which is not limited in the present disclosure.

In step S640, multimedia playback is performed by using the decrypted encoding information and the unencrypted encoding information.

After the decrypting process, there is no encrypted encoding information in the encoding information in the multimedia file, thereby achieving the lossless playback of the multimedia file. In the specific playback, the encoding information may be decoded by selecting a decoder in a corresponding format according to a format of the multimedia file, to obtain multimedia data, thereby achieving the multimedia playback.

It should be noted that, in a case that a multimedia file clicked by a user may not be an encrypted multimedia file, it may be determined that the user has the permission to decrypt the target multimedia file in determining the user's permission. Since a decryption algorithm of the target multimedia file cannot be obtained, there is no operation of decrypting the encoding information.

In addition, it may be determined firstly whether the target multimedia file is an encrypted multimedia file when a user triggers the target multimedia file. If so, the method proceeds according to the flow shown in FIG. 6, and if not, the method may be proceed according to the conventional processing flow.

Based on the method for processing a multimedia file according to the embodiment of the present disclosure, upon an operation of triggering the target multimedia file by a user, the target multimedia file is decoded to obtain encoding information, and a user identity is verified. In a case that it is determined that the user does not have the permission to decrypt the target multimedia file, multimedia playback is performed by using the encoding information directly. In this case, the quality of the multimedia file played may be low. In a case that it is determined that the user has the permission to decrypt the target multimedia file, the encoding information is decrypted by invoking a decryption algorithm corresponding to the target multimedia file, and multimedia playback is performed by using the decrypted encoding information. In this case, the played multimedia file is lossless, and the quality thereof is high.

Based on the method for processing a multimedia file shown in FIG. 6, a device for processing a multimedia file is further provided according to the present disclosure, which corresponds to the above method for processing a multimedia file. The device for processing a multimedia file may be applied to a player.

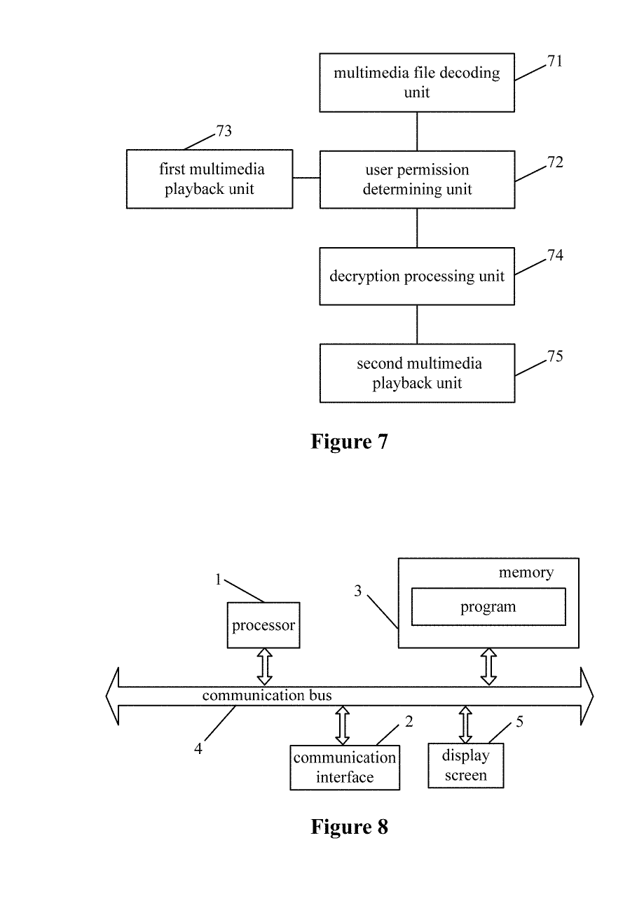

Reference is made to FIG. 7, which is a schematic structural diagram of a device for processing a multimedia file according to an embodiment of the present disclosure.

As shown in FIG. 7, the device includes a multimedia file decoding unit 71, a user permission determining unit 72, a first multimedia playback unit 73, a decryption processing unit 74 and a second multimedia playback unit 75.

The multimedia file decoding unit 71 is configured to decode a target multimedia file, in response to an operation of triggering the target multimedia file by a user, to obtain encoding information of the target multimedia file.

The user permission determining unit 72 is configured to determine whether the user has the permission to decrypt the target multimedia file.

The first multimedia playback unit 73 is configured to perform multimedia playback by using the encoding information, in a case of a negative determination from the user permission determining unit.

The decryption processing unit 74 is configured to decrypt the encrypted encoding information by means of a pre-set decryption algorithm corresponding to the target multimedia file to obtain the decrypted encoding information, in a case of a positive determination from the user permission determining unit. The pre-set decryption algorithm corresponding to the target multimedia file matches an encryption algorithm used to encrypt the target multimedia file.

The second multimedia playback unit 75 is configured to perform multimedia playback by using the decrypted encoding information.

Based on the device for processing a multimedia file according to the embodiment of the present disclosure, upon an operation of triggering the target multimedia file by a user, the target multimedia file is decoded to obtain encoding information, and a user identity is verified. In a case that it is determined that the user does not have the permission to decrypt the target multimedia file, multimedia playback is performed by using the encoding information directly. In this case, the quality of the multimedia file played may be low. In a case that it is determined that the user has the permission to decrypt the target multimedia file, the encoding information is decrypted by invoking a decryption algorithm corresponding to the target multimedia file, and multimedia playback is performed by using the decrypted encoding information. In this case, the played multimedia file is lossless, and the quality thereof is high.

A server is further provided according to an embodiment of the present disclosure. The server may include the device for processing multimedia file shown above in FIG. 2, and the description of the device for processing a multimedia file may refer to the above description of corresponding parts, which is not repeated herein.

Hereinafter a hardware structure of the server is described according to an embodiment of the present disclosure. A part of the following description involving the processing of a multimedia file may refer to the above description of corresponding parts. FIG. 8 is a schematic diagram of the hardware structure of a server according to an embodiment of the present disclosure.

Referring to FIG. 8, the server may include a processor 1, a communication interface 2, a memory 3, a communication bus 4 and a display screen 5.

The processor 1, the communication interface 2, the memory 3 and the display screen 5 communicate with each other via the communication bus 4.

Optionally, the communication interface 2 may be an interface of a communicate module, such as an interface of a GSM module.

The processor 1 is configured to execute a program.

The memory 3 is configured to stores the program.

The program may include program codes, and the program codes include operational instructions of the processor.

The processor 1 may be a central processing unit CPU, or an application specific integrated circuit (ASIC), or one or more integrated circuits configured for embodying the embodiment of the present disclosure.

The memory 3 may include a high-speed RAM memory, or may also include a non-volatile memory, such as at least one disk memory.

Specifically, the programs may be configured to:

acquire encoding information of a multimedia file to be processed;

select encoding information to be encrypted from the encoding information based on a pre-set strategy;

encrypt the encoding information to be encrypted, and form new encoding information by the encrypted encoding information and unencrypted encoding information; and

encode the new encoding information to obtain an encoded multimedia file.

It should be noted that, in the present disclosure, the relational terms, such as first and second or the like, are used merely to distinguish one entity or operation from another entity or operation, without necessarily requiring or implying that any such actual relations or orders exist among the entities or operations. Moreover, terms such as, “including”, “comprising”, or any other variation thereof, are intended to cover a non-exclusive inclusion, such that a process, a method, an article, or an apparatus including a series of elements may not only include those elements, but include other elements not expressly listed or inherent to the process, the method, the article, or the apparatus. Without more constraints, an element preceded by “includes a . . . ” does not preclude the existence of additional identical elements in the process, the method, the article, or the apparatus that includes the element.

Various embodiments of the present specification are described in a progressive manner and each embodiment places emphasis on the difference from other embodiments. Therefore, one embodiment can refer to other embodiments for the same or similar parts.

According to the above description of the disclosed embodiments, the present disclosure can be implemented or used by those skilled in the art. Various modifications made to these embodiments may be obvious for those skilled in the art, and a normal principle defined in the present disclosure may be implemented in other embodiments without departing from the spirit or scope of the disclosure. Therefore, the present disclosure is not limited to the embodiments described herein but confirms to a widest scope in accordance with principles and novel features disclosed in the present disclosure.

1. A method for processing a multimedia file, comprising:
acquiring encoding information of a multimedia file to be processed;
selecting encoding information to be encrypted from the encoding information based on a pre-set strategy;
encrypting the encoding information to be encrypted, and forming new encoding information by the encrypted encoding information and unencrypted encoding information; and
encoding the new encoding information to obtain an encoded multimedia file,
wherein the method is performed by a processor of a device configured to process a multimedia file.

2. The method according to claim 1, wherein the encoding information to be encrypted comprises at least one of a quantization parameter and discrete cosine transform coefficients of the multimedia file.

3. The method according to claim 2, wherein the selecting the encoding information to be encrypted from the encoding information based on the pre-set strategy comprises at least one of:
selecting the quantization parameter in the encoding information as the encoding information to be encrypted; and
determining a pre-set number of discrete cosine transform coefficients as the encoding information to be encrypted.

4. The method according to claim 1, wherein the encrypting the encoding information to be encrypted comprises:
encrypting the encoding information to be encrypted by a permutation encryption algorithm.

5. The method according to claim 2, wherein the encrypting the encoding information to be encrypted comprises:
encrypting the encoding information to be encrypted by a permutation encryption algorithm.

6. The method according to claim 3, wherein the encrypting the encoding information to be encrypted comprises:
encrypting the encoding information to be encrypted by a permutation encryption algorithm.

7. The method according to claim 1, wherein the acquiring the encoding information of the multimedia file to be processed comprises:
decoding the compressed multimedia file to be processed to obtain the encoding information of the multimedia file to be processed.

8. A method for processing a multimedia file, comprising:
decoding a target multimedia file, in response to an operation of triggering the target multimedia file by a user, to obtain encoding information of the target multimedia file, wherein the encoding information comprises encrypted encoding information and unencrypted encoding information;
determining whether the user has permission to decrypt the target multimedia file;
performing multimedia playback by using the unencrypted encoding information in the encoding information, in a case that it is determined that the user does not have the permission to decrypt the target multimedia file;
decrypting the encrypted encoding information to obtain decrypted encoding information, in a case that it is determined that the user has the permission to decrypt the target multimedia file; and
performing multimedia playback by using the decrypted encoding information and the unencrypted encoding information,
wherein the method is performed by a processor of a device configured to process a multimedia file.

9. The method according to claim 8, wherein the decoding a target multimedia file comprises:
decoding the target multimedia file by an entropy decoding method.

10. The method according to claim 8, wherein the determining whether the user has permission to decrypt the target multimedia file comprises at least one of:
determining whether the user has purchased the copyright of the target multimedia file; and
determining whether the user's identity meets a preset condition.

11. A device for processing a multimedia file, comprising one or more processors and a memory for storing program instructions, wherein the one or more processors are configured to execute the program instructions to:
acquire encoding information of a multimedia file to be processed;
select encoding information to be encrypted from the encoding information based on a pre-set strategy;
encrypt the encoding information to be encrypted, and form new encoding information by the encrypted encoding information and unencrypted encoding information; and
encode the new encoding information to obtain an encoded multimedia file.

12. The device according to claim 11, wherein the encoding information to be encrypted comprises at least one of a quantization parameter and discrete cosine transform coefficients of the multimedia file.

13. The device according to claim 12, wherein the one or more processors are configured to execute the program instructions further to perform at least one of:
select the quantization parameter in the encoding information as the encoding information to be encrypted; and
determine a pre-set number of discrete cosine transform coefficients as the encoding information to be encrypted.

14. The device according to claim 11, wherein the one or more processors are further configured to execute the program instructions to:
encrypt the encoding information to be encrypted by a permutation encryption algorithm.

15. The device according to claim 12, wherein the one or more processors are further configured to execute the program instructions to:
encrypt the encoding information to be encrypted by a permutation encryption algorithm.

16. The device according to claim 13, wherein the one or more processors are further configured to execute the program instructions to:
encrypt the encoding information to be encrypted by a permutation encryption algorithm.

17. The device according to claim 11, wherein the one or more processors are further configured to execute the program instructions to:
decode the compressed multimedia file to be processed to obtain the encoding information of the multimedia file to be processed.
